(19) United States
(12) Patent Application Publication
(10) Pub. No.: US 2007/0195962 A1
(43) Pub. Date: Aug. 23, 2007

(54) Apparatus and method for outputting audio data using wireless terminal

(75) Inventors: Sang-Don Kim, Suwon-si (KR); Byeng-Sang Jung, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/699,217

(22) Filed: Jan. 29, 2007

(30) Foreign Application Priority Data
Jan. 27, 2006 (KR) 2006-9038

(51) Int. Cl. H04H 5/00

(52) U.S. Cl. 381/11

(57) ABSTRACT

Provided is an apparatus and method for outputting audio data using a wireless terminal to output audio data of an external audio device from an audio data output device performing wireless communication with the wireless terminal. The apparatus includes an external audio device for outputting audio data to the wireless terminal when connected to the wireless terminal; the wireless terminal for encoding the audio data input from the external audio device when connected to the external audio device and transmitting the encoded audio data to an audio data output device in a wireless communication state; and the audio data output device for performing wireless communication with the wireless terminal, decoding the encoded audio data of the external audio device received from the wireless terminal through the wireless communication, and outputting the decoded audio data.

### PRIORITY

This application claims priority under 35 U.S.C. § 119 to an application entitled “Apparatus and Method for Outputting Audio Data Using Wireless Terminal” filed in the Korean Intellectual Property Office on Jan. 27, 2006 and assigned Ser. No. 2006-9038, the contents of which are incorporated herein by reference.

### BACKGROUND OF THE INVENTION

1. Field of the Invention

The present invention relates generally to an apparatus and method for outputting audio data using a wireless terminal, and in particular, to an apparatus and method for outputting audio data using a wireless terminal to output audio data of an external audio device from an audio data output device performing wireless communication with the wireless terminal.

2. Description of the Related Art

Bluetooth® is one of wireless interface standards for wireless connection between portable devices such as cellular phones and portable personal computers (PCs), network access points, and other peripherals, which are small-sized and low-priced and have low power consumption. Bluetooth® is a communication technology for connecting devices separated from each other by commonly 10 m (a maximum of 100 m) regardless of obstacles, and a data rate of Bluetooth® is 433.9 kbps in a symmetrical communication mode and 723.2 kbps in an asymmetrical communication mode. In addition, for voice transmission, a 64 kbps sync transmission method is used, and a maximum of three voice channels can be used. Furthermore, 10 Mbps-class technology for transmitting a moving picture has been being developed.

Recently, wireless terminals in which an advanced audio distribution profile (A2DP) is implemented have become available on the market. The A2DP is a profile for allowing a conventional Bluetooth®-equipped wireless terminal using a headset profile and a hands free profile and supporting only mono sound to support stereo sound. In the Bluetooth® A2DP, a sub band codec (SBC) is used as a Bluetooth® standard codec. That is, if audio data obtained by encoding any decoded audio data using the SBC in a wireless terminal is transmitted to a Bluetooth® stereo headset, the Bluetooth® stereo headset outputs stereo sound by decoding the SBC-encoded audio data. However, a conventional wireless terminal having a Bluetooth® wireless communication module can output audio data only stored therein to a Bluetooth® stereo headset.

### SUMMARY OF THE INVENTION

An object of the present invention is to substantially solve at least the above problems and/or disadvantages and to provide at least the advantages below. Accordingly, an object of the present invention is to provide an apparatus and method for outputting audio data using a wireless terminal to output audio data of an external audio device from an audio data output device performing wireless communication with the wireless terminal.

According to one aspect of the present invention, there is provided an apparatus for outputting audio data using a wireless terminal, the apparatus including: an external audio device for outputting audio data to the wireless terminal when connected to the wireless terminal; the wireless terminal for encoding the audio data input from the external audio device when connected to the external audio device and transmitting the encoded audio data to an audio data output device in a wireless communication state; and the audio data output device for performing wireless communication with the wireless terminal, decoding the encoded audio data of the external audio device received from the wireless terminal through the wireless communication, and outputting the decoded audio data.

According to another aspect of the present invention, there is provided a method of outputting audio data using a wireless terminal, the method including: performing wireless communication between the wireless terminal and an audio data output device; and if the wireless terminal and an external audio device are connected, transmitting, by the wireless terminal, audio data input from the external audio device to the audio data output device through the wireless communication and allowing the audio data output device to output the audio data.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram explaining an operation of transmitting audio data of an external audio device from an audio data output device via a wireless terminal according to the present invention;

FIG. 2 is a block diagram of the wireless terminal of FIG. 1 according to the present invention; and

FIG. 3 is a flowchart illustrating a process of transmitting audio data of an external audio device to an audio data output device from a wireless terminal according to the present invention.

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. Herein, it is assumed that wireless communication performed between a wireless terminal and an audio data output device is Bluetooth® wireless communication and the audio data output device is a Bluetooth® stereo headset.

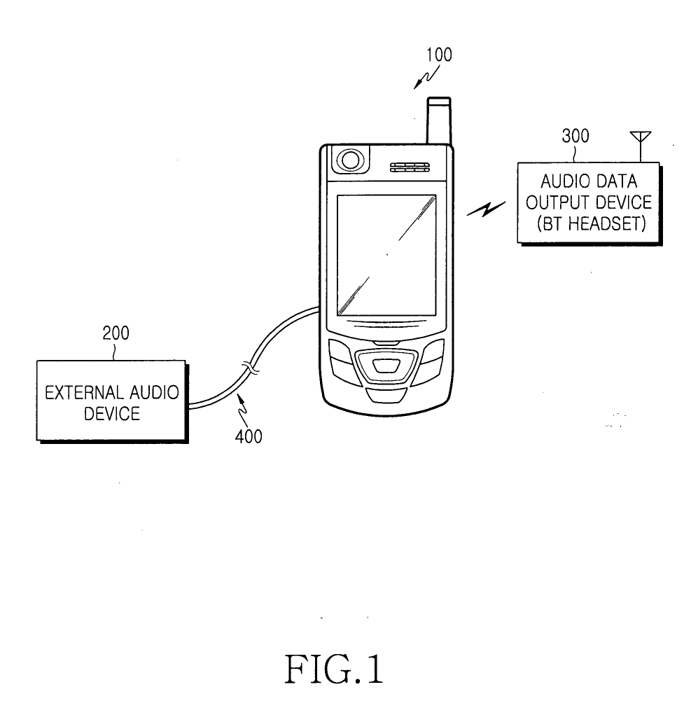

FIG. 1 is a diagram explaining an operation of outputting audio data of an external audio device 200 from a headset 300, which is an audio data output device, via a wireless terminal 100 according to the present invention.

Referring to FIG. 1, the external audio device 200 stores audio data and can be connected to the wireless terminal 100 via an interface data cable 400. When the external audio device 200 is connected to the wireless terminal 100 via the interface data cable 400, the external audio device 200 outputs the stored audio data to the wireless terminal 100. Herein, the audio data output to the wireless terminal 100 from the external audio device 200 can be analog audio data or digital pulse code modulation (PCM) data.

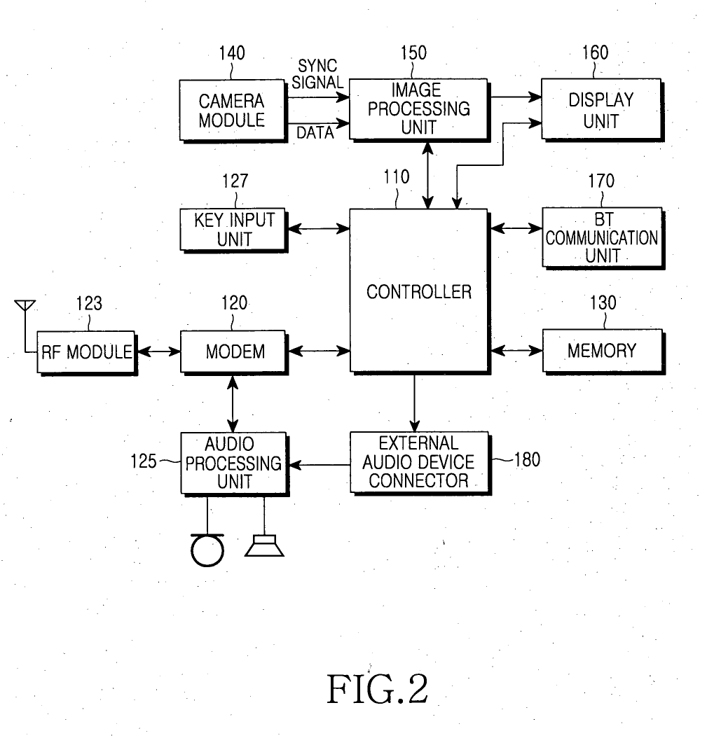

The wireless terminal 100 can perform Bluetooth® wireless communication with the headset 300. To do this, each of the wireless terminal 100 and the headset 300 includes a Bluetooth® wireless communication module. When the wireless terminal 100 is connected to the external audio device 200 via the interface data cable 400, the wireless terminal 100 encodes audio data input from the external audio device 200 and transmits the encoded audio data to the headset 300 connected using the Bluetooth® wireless communication. The wireless terminal 100 can also encode audio data stored therein and transmit the encoded audio data to the headset 300 connected using the Bluetooth® wireless communication. The wireless terminal 100 will be described in detail with reference to FIG. 2.

The headset 300 is an audio data output device and includes a Bluetooth® wireless communication module to perform the Bluetooth® wireless communication with the wireless terminal 100. The headset 300 decodes the encoded audio data of the external audio device 200 or the wireless terminal 100, which is received from the wireless terminal 100 using the Bluetooth® wireless communication, and outputs the decoded audio data.

FIG. 2 is a block diagram of the wireless terminal 100 of FIG. 1 according to the present invention.

Referring to FIG. 2, a radio frequency (RF) module 123 performs a wireless communication function of the wireless terminal 100. The RF module 123 includes an RF transmitter for up-converting a frequency of a transmission signal and amplifying the up-converted transmission signal, and an RF receiver for low-noise-amplifying a received signal and down-converting a frequency of the low-noise-amplified signal.

A modem 120 includes a transmitter for encoding and modulating the transmission signal and a receiver for demodulating and decoding the received signal. The modem 120 also encodes digital PCM audio data input from an audio processing unit 125 and outputs the encoded digital PCM audio data to a controller 110. Preferably, the modem 120 performs encoding using SBC, which is a Bluetooth® standard codec.

The audio processing unit 125 may include a codec, which includes a data codec for processing packet data and an audio codec for processing an audio signal such as voice. The audio processing unit 125 converts a digital audio signal received from the modem 120 to an analog audio signal using the audio codec and reproduces the converted analog audio signal for output through a speaker, and converts an analog audio signal generated by a microphone to a digital audio signal using the audio codec and transmits the converted digital audio signal to the modem 120. Alternatively, the codec may be included separately or in the controller 110. Preferably the audio processing unit 125 also transmits digital PCM audio data stored in a memory 130 to the modem 120. In addition, when the external audio device 200 is connected via the interface data cable 400, the audio processing unit 125 transmits audio data input from the external audio device 200 to the modem 120. Herein, if the audio data input from the external audio device 200 is analog audio data, the audio processing unit 125 converts the analog audio data to digital PCM audio data and transmits the converted digital PCM audio data to the modem 120.

The memory 130 includes a program memory and a data memory. The program memory stores programs for controlling a general operation of the wireless terminal 100 and control programs for transmitting audio data of the external audio device 200 to the headset 300 via the Bluetooth® wireless communication module. The data memory temporarily stores data generated while executing the programs.

The controller 110 controls a general operation of the wireless terminal 100. In addition, the controller 110 may include the modem 120 and the codec. Furthermore, when the external audio device 200 is connected via the interface data cable 400, the controller 110 controls the audio data of the external audio device 200 to be transmitted to the headset 300 via the Bluetooth® wireless communication module. In addition, the controller 110 controls the audio data of the external audio device 200 or the audio data stored in the memory 130 to be selectively transmitted to the headset 300 via the Bluetooth® wireless communication module.

A Bluetooth® wireless communication module 170 is connected to a Bluetooth® wireless communication module included in the headset 300 and performs the Bluetooth® wireless communication so that data can be transmitted and received between the wireless terminal 100 and the headset 300.

An external audio device connector 180 is connected to an audio data output terminal of the external audio device 200 via the interface data cable 400. The controller 110 controls the external audio device connector 180 to receive the audio data output from the audio data output terminal of the external audio device 200 via the interface data cable 400 and transmits the received audio data to the audio processing unit 125.

A camera module 140 includes a camera sensor for capturing image data and converting a captured optical signal to an electrical signal and a signal processing unit for converting an analog image signal output from the camera sensor to digital data. Herein, it is assumed that the camera sensor is a charge coupled device (CCD), and the signal processing unit can be realized using a digital signal processor (DSP). The camera sensor and the signal processing unit can be realized in one body or separately.

An image processing unit 150 generates screen data to display the image signal output from the camera module 140. The image processing unit 150 processes the image signal output from the camera module 140 on a per-frame basis and outputs the processed frame image data according to characteristics of a display unit 160 and the size of a screen of the display unit 160. The image processing unit 150, including an image codec, encodes the frame image data to be displayed on the display unit 160 according to a predetermined method and decodes the encoded frame image data to the original frame image data. Herein, the image codec can be a JPEG codec, an MPEG4 codec, or a Wavelet codec. It is assumed that the image processing unit 150 has an on-screen display (OSD) function, and the image processing unit 150 can output OSD data according to the size of the screen under the control of the controller 110.

The display unit 160 displays the frame image data input from the image processing unit 150 and user data input from the controller 110 on the screen. The display unit 160 can be comprised of a liquid crystal display (LCD), and in this case, the display unit 160 can include an LCD controller, a memory for storing image data, and an LCD display component. If the LCD is realized with a touch screen scheme, the display unit 160 can serve as an input unit. Preferably the display unit 160 displays an indication that the audio data of the external audio device 200 is being transmitted to the headset 300 via the Bluetooth® wireless communication. In addition, the display unit 160 displays information on the audio data of the external audio device 200, which is being transmitted to the headset 300.

A key-input unit 127 includes keys for inputting character and number information and function keys for setting various functions.

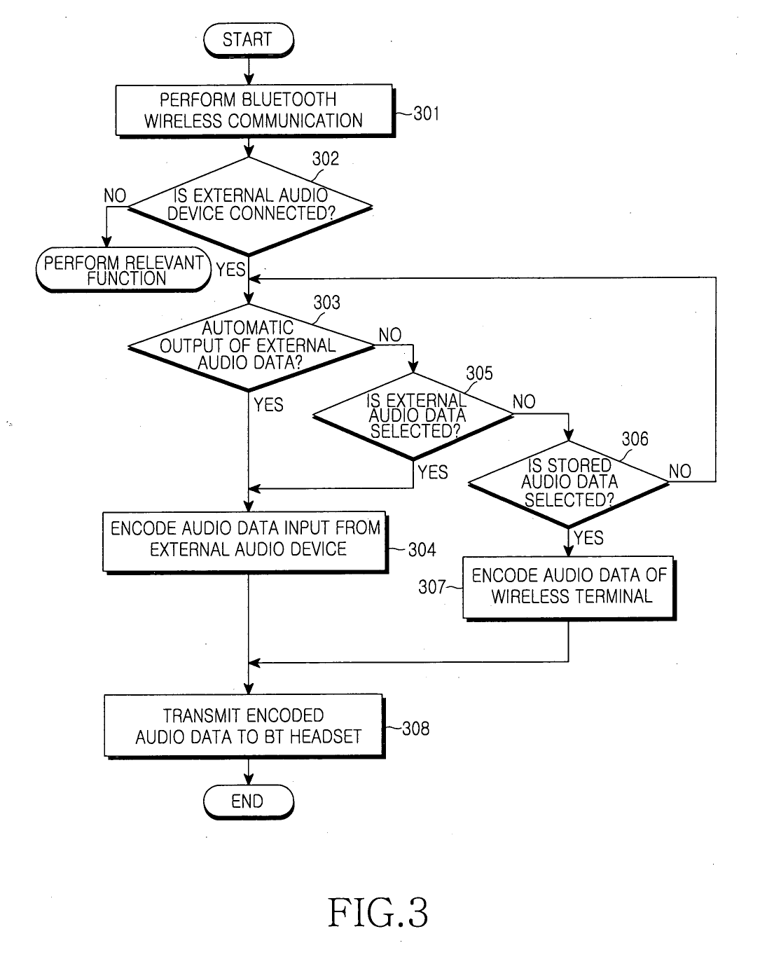

FIG. 3 is a flowchart illustrating a process of transmitting audio data of an external audio device to a headset, which is an audio data output device, from a wireless terminal according to the present invention.

The process of FIG. 3 will now be described in detail with reference to FIGS. 1 and 2.

Referring to FIG. 3, the wireless terminal 100 is connected to the headset 300, which is an audio data output device, using the Bluetooth® wireless communication in step 301. If the external audio device 200 is connected to the wireless terminal 100, the controller 110 senses this in step 302 and determines an output type of external audio data set in the wireless terminal 100. If an external audio device is not connected in step 302, the terminal 100 performs other relevant functions.

The connection between the wireless terminal 100 and the external audio device 200 is achieved by connecting one end of the interface data cable 400 to the external audio device connector 180 of the wireless terminal 100 and connecting the other end of the interface data cable 400 to the audio output terminal of the external audio device 200, and by doing this, the controller 110 can sense in step 302 that the external audio device 200 is connected to the wireless terminal 100.

As a result obtained by determining an output type of external audio data set in the wireless terminal 100, if an automatic output of external audio data is set in the wireless terminal 100, the controller 110 senses this in step 303 and encodes audio data input from the external audio device 200 connected via the interface data cable 400 in step 304. Herein, if the audio data input from the external audio device 200 is digital PCM audio data, the controller 110 controls the modem 120 to encode the input digital PCM audio data. In addition, if the audio data input from the external audio device 200 is analog audio data, the controller 110 controls the audio processing unit 125 to convert the analog audio data to digital PCM audio data and then controls the modem 120 to encode the converted digital PCM audio data.

As a result obtained by determining an output type of external audio data set in the wireless terminal 100, if the automatic output of external audio data is not set in the wireless terminal 100, the controller 110 senses this and displays types of audio data on the display unit 180 so that the user can select one.

If external audio data is selected from the displayed audio data types, the controller 110 senses this in step 305 and encodes audio data input from the external audio device 200 connected via the interface data cable 400 in step 304.

However, if audio data of the wireless terminal 100 is selected from the displayed audio data types, the controller 110 senses this in step 306 and encodes audio data selected from among audio data stored in the memory 130 in step 307.

In step 308, the controller 110 controls the Bluetooth® wireless communication module 170 to transmit the audio data encoded in steps 304 or 307 to the headset 300 connected using the Bluetooth® wireless communication.

The headset 300, which has received the encoded audio data through the Bluetooth® wireless communication, decodes and outputs the received audio data.

While the audio data of the external audio device 200 is being transmitted to the headset 300 via the wireless terminal 100 and output, the display unit 160 of the wireless terminal 100 displays an indication that the audio data of the external audio device 200 is being transmitted to the headset 300. In addition, the display unit 160 of the wireless terminal 100 can display play information of the audio data of the external audio device 200 and types of audio data of the external audio device 200 to be played. In addition, the wireless terminal 100 can perform a control function, such as play/stop/fast forward/backward, for the audio data of the external audio device 200 transmitted to the headset 300.

As described above, according to the present invention, by providing a method of outputting audio data using a wireless terminal, a user can listen to audio data of an external audio device using an audio data output device connected to the wireless terminal through wireless communication.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for outputting audio data using a wireless terminal, the apparatus comprising:
an external audio device for outputting audio data to the wireless terminal when connected to the wireless terminal;
the wireless terminal for encoding the audio data input from the external audio device when connected to the external audio device and transmitting the encoded audio data to an audio data output device in a wireless communication state; and
the audio data output device for performing wireless communication with the wireless terminal, decoding the encoded audio data of the external audio device received from the wireless terminal through the wireless communication, and outputting the decoded audio data.

2. The apparatus of claim 1, further comprising an interface data cable for connecting between the wireless terminal and the external audio device.

3. The apparatus of claim 1, wherein the audio data output device is a headset.

4. The apparatus of claim 1, wherein the wireless communication is Bluetooth® wireless communication.

5. A method of outputting audio data using a wireless terminal, the method comprising the steps of:
performing wireless communication between the wireless terminal and an audio data output device; and
if the wireless terminal and an external audio device are connected, transmitting, by the wireless terminal, audio data input from the external audio device to the audio data output device through the wireless communication and allowing the audio data output device to output the audio data.

6. The method of claim 5, wherein the transmitting and allowing step the audio data to the audio data output device and allowing comprises:
if the wireless terminal and the external audio device are connected, determining, by the wireless terminal, an output type of external audio data set therein;
if an automatic output of external audio data is set in the wireless terminal, encoding, by the wireless terminal, audio data input from the external audio device and transmitting the encoded audio data to the audio data output device through the wireless communication; and
if the encoded audio data of the external audio device is received from the wireless terminal, decoding, by the audio data output device, the encoded audio data and outputting the decoded audio data.

7. The method of claim 6, further comprising:
if the automatic output of external audio data is not set in the wireless terminal, displaying types of audio data on the wireless terminal;
if external audio data is selected from the displayed audio data types, encoding, by the wireless terminal, audio data input from the external audio device, transmitting the encoded audio data to the audio data output device through the wireless communication, and outputting, by the audio data output device, the received audio data; and
if audio data of the wireless terminal is selected from the displayed audio data types, encoding stored audio data, transmitting the encoded audio data to the audio data output device through the wireless communication, and outputting, by the audio data output device, the received audio data.

8. The method of claim 5, wherein the wireless terminal and the audio data output device perform Bluetooth® wireless communication.
